(19) United States
(12) Patent Application Publication
(10) Pub. No.: US 2015/0296542 A1
(43) Pub. Date: Oct. 15, 2015

(54) PERFORMING RANDOM ACCESS IN CARRIER AGGREGATION

(71) Applicants: Youn Hyoung Heo, Bucheon-si (KR); Changhoi Koo, Plano, TX (US); Zhijun Cai, Herndon, VA (US); Takashi Suzuki, Ichikawa (JP)

(72) Inventors: Youn Hyoung Heo, Bucheon-si (KR); Changhoi Koo, Plano, TX (US); Zhijun Cai, Herndon, VA (US); Takashi Suzuki, Ichikawa (JP)

(73) Assignee: BLACKBERRY LIMITED, Waterloo, ON (CA)

(21) Appl. No.: 14/238,296

(22) PCT Filed: Aug. 11, 2011
(86) PCT No.: PCT/US11/47438

§ 371 Date: Sep. 19, 2014

(51) Int. Cl. H04W 74/08; H04L 1/00; H04W 72/04

(52) U.S. Cl. CPC H04W 74/0833; H04W 72/042; H04L 1/0038; H04W 72/0453

(57) ABSTRACT

Systems, apparatus and methods can be implemented for performing random access in carrier aggregation. A user equipment (UE) can transmit a random access preamble to a secondary access device of a second carrier, where the UE is served by both a primary access device and the secondary access device, and the UE is configured to attempt a total number of blind decoding attempts for decoding physical downlink control channel candidates of a UE-specific search space of the second carrier. The UE can perform a first blind decoding of first PDCCH candidates of the common search space of the second carrier, and perform a second blind decoding of second PDCCH candidates of the UE specific search space of the second carrier. A number of blind decoding attempts for the first and second blind decodings is less than or equal to the configured total number of blind decoding attempts.

### TECHNICAL FIELD

This disclosure relates to wireless communications and, more particularly, to performing random access in carrier aggregation.

### BACKGROUND

Long Term Evolution Advanced (LTE-A) is a mobile communication standard that is standardized by the 3rd Generation Partnership Project (3GPP) as a major enhancement of the 3GPP LTE standard. In LTE-A, carrier aggregation is introduced in order to support wider transmission bandwidth than LTE and potentially increase the peak data rate. Using carrier aggregation, multiple downlink/uplink component carriers may be aggregated, and radio resources may be allocated to user equipment (UE) based on the aggregation of carriers. In some instances, one of the multiple carriers may be designated as the primary cell (PCell). The PCell may provide system information and configure physical uplink control channel (PUCCH). The remaining carriers may be defined as the secondary cell (SCell). In some instances, a UE may be simultaneously served by both the PCell and the SCell.

The access device serving a PCell may be a primary access device, and the access device serving a SCell may be a secondary access device. LTE-A system may use a physical downlink control channel (PDCCH) to distribute data control information (DCI) messages amongst UEs. The PDCCH may include control channel element (CCE) candidates that are used to transmit DCI messages from an access device to UEs. The access device may select one or an aggregation of CCEs to transmit a DCI message to a UE. The UE may blind decode a subset of the PDCCH CCE candidates (or PDCCH candidates) when searching for a DCI message. In some instances, for each sub-frame, a UE may search both a common search space for PDCCH candidates transmitted to multiple UEs and a UE specific search space for PDCCH candidates to each UE.

### DESCRIPTION OF DRAWINGS

FIG. 1a is a schematic representation of an example network deployment scenario;

FIG. 1b is a schematic representation of another example network deployment scenario;

FIG. 2 is a schematic of an example process for blind decoding PDCCH candidates of a second carrier;

FIG. 3 is a schematic of an example media access control (MAC) protocol data unit (PDU) format for a random access response (RAR) MAC control element (CE);

FIG. 4 is a schematic showing two MAC PDU subheaders;

FIG. 5 is a diagram showing an example physical random access channel (PRACH) procedure;

FIG. 6 is a diagram illustrating a TA MAC CE and a TA command MAC CE;

FIG. 7 is a flowchart illustrating an example process of performing random access to a secondary access device;

FIG. 8 is a flowchart illustrating another example process of performing random access to a secondary access device;

FIG. 9 is a flowchart illustrating an example process of transmitting a random access response;

FIG. 10 is a flowchart illustrating yet another example process of performing random access to a secondary access device; and

FIG. 11 is a flowchart illustrating another example process of transmitting a random access response.

Like reference symbols in the various drawings indicate like elements.

### DETAILED DESCRIPTION

The present disclosure is directed to systems and methods that perform random access in carrier aggregation. In wireless communication systems, such as Long Term Evolution Advanced (LTE-A) systems, a user equipment (UE) may be served by multiple access devices including a primary access device and a secondary access device. The primary access device may serve a primary cell (PCell) of a first carrier, and the secondary access device may serve a secondary cell (SCell) of a second carrier. In some instances, the location of the primary access device and the location of the secondary access device may be different. Accordingly, the primary and secondary access devices' uplink configurations for the UE may also be different. In these cases, in addition to performing a regular random access procedure to obtain configuration information from the primary access device, the UE may also perform a random access procedure to obtain configuration information from the secondary access device. The configuration information may include a timing advance (TA) for uplink synchronization, and an uplink grant for uplink radio resource allocation.

In some implementations, a UE may transmit a random access preamble to a secondary access device to initiate a random access procedure. After receiving the random access preamble, the secondary access device may transmit a random access response that includes uplink configuration information to the UE. The random access response (RAR) may be scrambled using a random access radio network temporary identifier (RA-RNTI), where the RA-RNTI may be determined based on radio resources used to transmit the random access preamble. The RAR may be transmitted in the physical downlink shared channel (PDSCH) of the SCell. To help the UE locate the RAR, the secondary access device may encode data control information (DCI) associated with the RAR in a common search space of the physical downlink control channel (PDCCH) of the SCell. Therefore, the UE may identify DCI by performing blind decoding on PDCCH candidates in the common search space (CSS) of the PDCCH. The UE may then use the identified DCI to locate the RAR for the UE's uplink configuration information. The UE may also perform blind decoding on PDCCH candidates in a UE-specific search space (USS) of PDCCH. To avoid increasing the total number of blind decoding attempts, the UE may reduce the number of blind decoding attempts for the PDCCH candidates in the USS. In these implementations, the sum of the number of decoding attempts for the CSS and the reduced number of decoding attempts for USS may be equal to or less than the initial number of decoding attempts for the USS before the reduction.

In some implementations, instead of encoding the DCI as PDCCH candidates in the CSS to help the UE locate the RAR of the SCell, the secondary access device may encode the DCI as PDCCH candidates in the USS. Accordingly, the UE may perform blind decoding on the PDCCH candidates in the USS to identify the DCI associated with the RAR. In some implementations, a primary access device may encode the DCI associated with the RAR of the SCell. The primary access device may encode the DCI as PDCCH candidates in the CSS of the PCell. Accordingly, the UE may perform blind decoding on the PDCCH candidates in the CSS of the PCell to identify the DCI, and then, use the identified DCI to locate the RAR of the SCell.

As used herein, the term “UE” may refer to any mobile electronic device used by an end-user to communicate within a wireless communication system. UE may be referred to as mobile electronic device, user agent, user device, mobile station, subscriber station, or wireless terminal UE may be a cellular phone, personal data assistant (PDA), smartphone, laptop, tablet personal computer (PC), or other wireless communications device. Further, UEs may include pagers, portable computers, Session Initiation Protocol (SIP) phones, one or more processors within devices, or any other suitable processing devices capable of communicating information using a radio technology. The term UE may also refer to devices that have similar capabilities but that are not generally transportable, such as desktop computers, set-top boxes, or network nodes. The term “access device” may refer to any access network component, such as a base station, an LTE or LTE-A access device or eNode B (eNB), that may provide one or more UEs with access to other components.

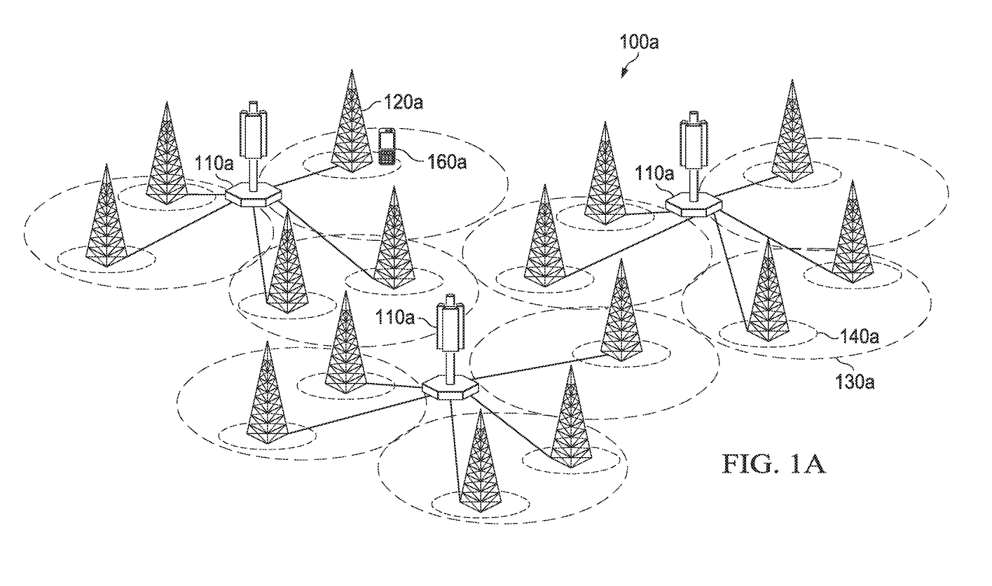

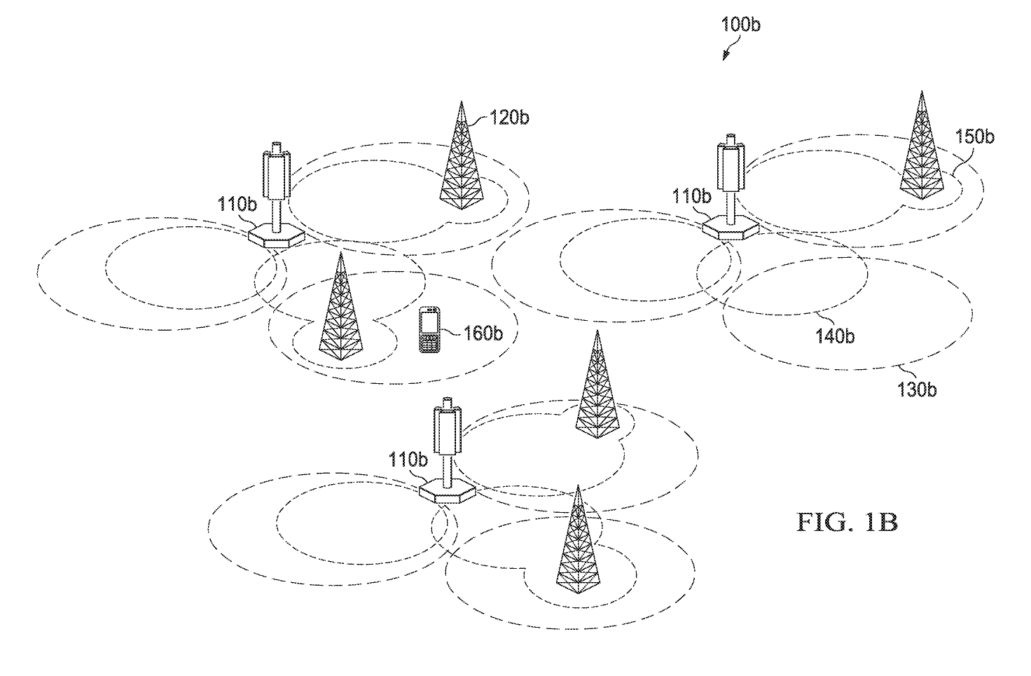

FIG. 1a is a schematic representation of an example network deployment scenario 100a suitable for some of the various implementations of the disclosure. In the illustrated deployment scenario 100a, primary access devices 110a (e.g., eNBs) may be used to provide macro coverage, and secondary access devices 120a (e.g., remote radio heads, frequency selective repeaters) may be used to provide enhanced throughput at wireless hot spots. The primary access device 110a may serve a first carrier of a PCell 130a, and the secondary access device 120a may serve a second carrier of a SCell 140a. A UE 160a is located in the coverage area of both the PCell 130a and SCell 140a. Thus, the first carrier associated with the PCell 130a and the second carrier associated with the SCell 140a may be aggregated. In these instances, the UE 160a may be simultaneously served, using carrier aggregation, by both the primary access device 110a and the secondary access device 120a.

FIG. 1b is a schematic representation of another example network deployment scenario 100b suitable for some of the various implementations of the disclosure. In the illustrated deployment scenario 100b, primary access devices 110b (e.g., eNBs) may be used to provide macro coverage, and secondary access devices 120b (e.g., remote radio heads, frequency selective repeaters) may be used to extend the coverage for at least one of the carriers served by the primary access devices 110b. The primary access device 110b may serve both a PCell 130b (a first carrier) and a SCell 140b (a second carrier), and the secondary access device 120b may serve a cell extension 150b of the SCell 140b. The cell extension 150b may extend the coverage area of the SCell 140b. The UE 160b located in the cell extension 150b is in the coverage area of both the first carrier and the second carrier. Thus, the first carrier associated with the PCell 130a and the second carrier associated with the SCell 140a may be aggregated. In these instances, the UE 160b located in the cell extension 150b of the SCell 140b may be simultaneously served, using carrier aggregation, by both the primary access device 110b and the secondary access device 120b.

For the deployment scenarios 100a and 100b illustrated respectively in FIG. 1a and FIG. 1b, the secondary access devices 120 are not co-located with the primary access devices 110. In these instances, the uplink signal propagation delays from a UE 160 to a serving primary access device 110 and a serving secondary access device 120 may be different. Furthermore, the uplink radio resource grant for the UE 160 of the PCell and the SCell may also be different. Therefore, in addition to performing random access to the primary access device 110, the UE 160 may also perform random access to the secondary access device 120, in order to obtain configuration information of the second carrier served by the secondary access device 120.

The UE 160 that is suitable for some of the various implementations of the disclosure may include hardware components such as a processor, a machine-readable medium such as a memory (e.g., solid-state, optical, magnetic, etc.), a transceiver, and an antenna. The access device 110, 120 that are suitable for some of the various implementations of the disclosure may also include hardware components that are similar or complementary to the previously-described hardware components of the UE 160. That is, the access device 110, 120 may include a processor, a machine-readable medium such as a memory, a transceiver, and an antenna. The hardware components of the access device 110, 120 may have functions that are similar to, or different from the corresponding hardware components of the UE 160 as described above.

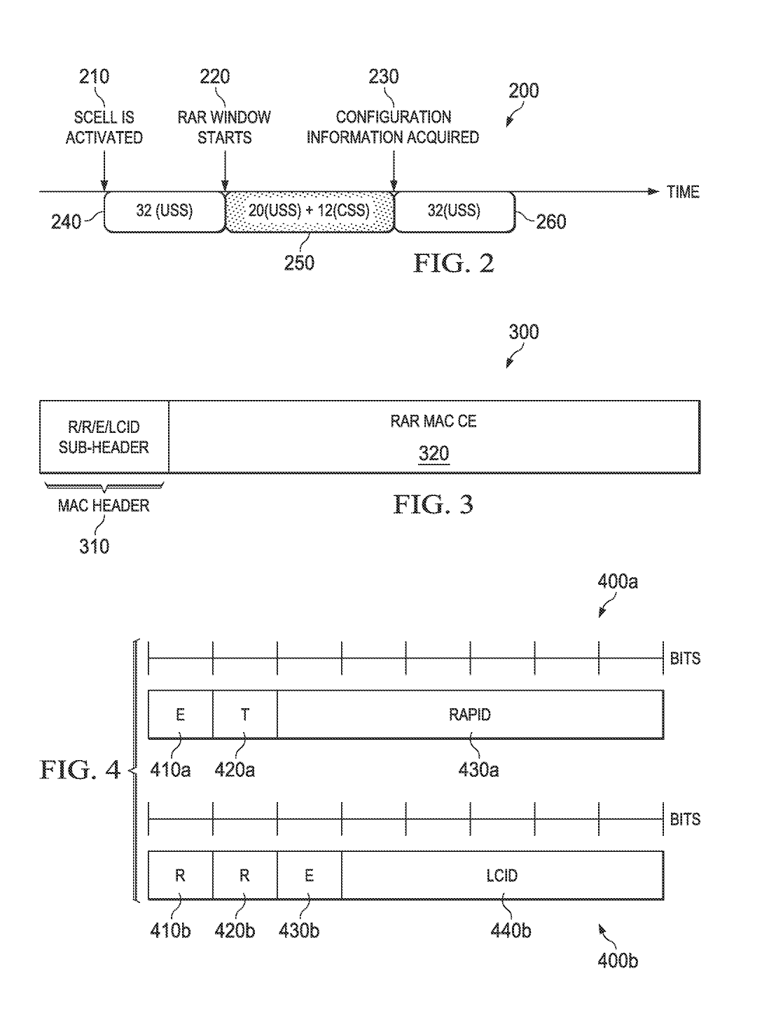

FIG. 2 is a schematic of an example process 200 for blind decoding PDCCH candidates of a second carrier. In the illustrated example process 200, the UE may perform blind decoding on PDCCH candidates in the CSS of the SCell, and use the decoded DCI to identify an RAR for configuration information associated with a secondary access device. When carrier aggregation is configured by higher layer (e.g., media access control layer, transport layer) signaling, the SCell is activated 210. The UE may monitor the USS to receive PDCCH information for downlink assignment, and/or PDCCH order. The PDCCH order may be an assignment of a random access preamble to be used by the UE in the SCell random access procedure. As illustrated, during the time period 240, between when the SCell is activated 210 and the RAR window starts 220, the number of blind decodes in the USS is 32. The 32 blind decodes (also referred to herein as decoding attempts) may include decoding two possible DCI format sizes with six control channel element (CCE) subsets of aggregation level 1 that includes one CCE, six CCE subsets of aggregation level 2 that includes 2 CCEs, two CCE subsets of aggregation level 4 that includes 4 CCEs and two CCE subsets of aggregation level 8 that includes 8 CCEs. The location of sixteen CCE subsets are a function of a specific Radio Network Temporary Identifier (RNTI) assigned to a UE, and may vary from one sub-frame to another. In some implementations, when the uplink MIMO transmission is configured, the number of blind decodes in the USS may be 48. When the UE receives a PDCCH order, the UE may transmit the random access preamble to the secondary access device. After the UE transmits the random access preamble, a RAR window may start 220. During the RAR window, the UE may start monitoring the CSS in addition to the USS in the SCell for the RAR. The RAR window 250 is a time period that may be determined based on the time when the UE starts transmitting the random access preamble. In some instances, the RAR window 250 may start at the subframe that contains the end of the preamble transmission plus three subframes. The RAR window 250 may have a length that is equal to ra-ResponseWindowSize subframes. In some implementations, the RAR window may be configured by higher layer signaling. As is shown in FIG. 2, the UE may perform 20 blind decodes in the USS and 12 blind decodes in the CSS in the RAR window 250. The 12 blind decoding attempts in the CSS may include decoding with two possible DCI format sizes having four CCE subsets of aggregation level 4, and 2 CCE subsets of aggregation level 8. The number of blind decoding attempts for the USS PDCCH candidates is reduced from 32 to 20, and the total number of blind decoding attempts (including USS and CSS) in the RAR window 250 is still 32. In some implementations, the UE may perform less than 20 blind decodes in the USS. The UE may be able to receive an RAR of the SCell, and use the RA-RNTI to decode the RAR to thereby acquire configuration information at 230. After the configuration information is acquired 230, the UE may resume regular monitoring 260 of the USS by performing 32 blind decodes per subframe. Based on the example process described above, the total number of blind decodes is maintained the same for identifying DCI associated with the RAR. In other words, no extra computational complexity is added to the UE for acquiring SCell configuration information.

In order to maintain a constant total number of blind decodes performed in the SCell PDCCH during the RAR window 250, the UE may cancel blind decoding of any subsets of PDCCH candidates in the USS. Table 1 shows an example of blind decoding attempts for PDCCH candidates in the USS during the RAR window 250 as compared to normal operation outside of the RAR window 240, 260 with respect to aggregation levels.

TABLE 1

| | Number of PDCCH candidates | Number of |
|---|---|---|
| Aggregation | monitored during normal operation | PDCCH monitored |
| level | (i.e. USS is monitored) | during RAR window |
| 1 | 6 | 4 |
| 2 | 6 | 4 |
| 4 | 2 | 1 |
| 8 | 2 | 1 |

In some implementations, the UE may stop monitoring PDCCH candidates configured by cell RNTI (C-RNTI) in the USS during the RAR window. In some implementations, the UE may monitor CCE subsets of a subset of the aggregation levels. For example, when the channel condition between the UE and a secondary access device is good enough to use the lower MCS level to achieve the same error probability, the CCE subset candidates may be encoded with a lower aggregation level (e.g. aggregation level 1, aggregation level 2). In these implementations, the UE may not monitor PDCCH candidates encoded with high aggregation levels (e.g., aggregation level 4, aggregation level 8). In some implementations, an access device may indicate a maximum aggregation level of CCEs during a SCell radio access channel (RACH) procedure to the UE. The UE may then decode PDCCH candidates with aggregation levels that are less than or equal to the indicated maximum aggregation level. For example, the access device may indicate to the UE that the maximum aggregation level of PDCCH candidates is 4. Based on receiving the indication, the UE may monitor PDCCH candidates with aggregation levels 1, 2 and 4.

In some implementations, more than one SCell may be activated for a UE during SCell RACH procedures. In these implementations, the secondary access device may indicate whether physical uplink shared channel (PUSCH) is scheduled during the SCell RACH procedures. When the uplink MIMO is configured, DCI format 4 is also scheduled to be monitored, and the number of blind decodes may increase to 44. Since the uplink PUSCH cannot be scheduled if uplink timing is not synchronized, the UE may cancel the scheduled monitoring of DCI format 4 before uplink timing synchronization. Therefore, the number of blind decodes may be maintained as 32 during the SCell RACH procedures. In some implementations, the UE may stop monitoring the CSS when a TA is acquired and/or when the RAR window 260 is expired.

The UE may not receive RAR until the RAR window has expired. After the RAR window is expired, the UE could re-transmit the random access preamble, or if the UE sends the random access preamble more than the allowed number of preamble transmissions, the UE may send the indication to the eNB with higher layer/MAC or physical layer signaling that the timing synchronization of the SCell has not been completed.

FIG. 3 is a schematic of an example media access control (MAC) protocol data unit (PDU) format 300 for an RAR MAC control element (CE) 320. In the illustrated example, the DCI for a UE to identify SCell RAR is encoded in PDCCH candidates in the USS of the SCell. The MAC PDU format 300 may be a format used by an RAR MAC CE 320. The RAR MAC CE 320 is configured by C-RNTI and is transmitted on the PDCCH of the SCell. The MAC header 310 of the RAR MAC CE 320 may be the same as the header of a normal MAC PDU. In some implementations, the UE may monitor PDCCH DCI format 1A configured by C-RNTI to decode DCI. In order to distinguish PDCCH scheduling RAR MAC CE 320 from downlink shared channel (DL-SCH) MAC PDU, a reserved/new value may be assigned to the logical channel identifier (LCID) in the MAC header 310 of the RAR MAC CE 320. The reserved value is different from the LCID value for a DL-SCH MAC PDU. An example LCID assignment is shown in Table 2.

TABLE 2

| Index | LCID values |
|---|---|
| 00000 | CCCH |
| 00001-01010 | Identity of the logical channel |
| 01011-11010 | Reserved |
| 11011 | Random Access Response command |
| 11100 | UE Contention Resolution Identity |
| 11101 | Timing Advance Command |
| 11110 | DRX Command |
| 11111 | Padding |

Since the RAR is sent in response to the random access preamble transmitted by a specific UE, the introduction of a new LCID value for identifying RAR may not affect the legacy UEs. If the UE identifies LCID value as 11011 (as defined in Table 2) in the MAC header 310, the remaining MAC payload may be interpreted by the UE as RAR MAC CE 320.

In some implementations, the UE may monitor PDCCH DCI format 1A configured by RA-RNTI in the USS instead of C-RNTI. Since the size of PDCCH 1A configured by RA-RNTI is the same as PDCCH 1A configured by C-RNTI in case of the separate scheduling, the number of blind decodes may not change. If the cross carrier scheduling is configured, the size of PDCCH 1A configured by RA-RNTI is different from the size configured by C-RNTI due to the carrier indicator field in PDCCH 1A configured by C-RNTI. In this case, in order to have the same size, the carrier indicator field may be included in PDCCH 1A configured by RA-RNTI and transmitted in the USS. The carrier indicator field in PDCCH 1A configured by RA-RNTI may be reserved as a certain value or used to support the cross carrier scheduling for PDCCH 1A configured by RA-RNTI. If the cross carrier scheduling is supported, RAR could be located in other serving cell than the corresponding SCell.

FIG. 4 is a schematic showing two MAC PDU subheaders 400a, 400b. Similar to the example described in the illustration of FIG. 3, the DCI for a UE to identify RAR is encoded as PDCCH candidates in the USS of the SCell, and the UE may monitor PDCCH DCI format 1A configured by C-RNTI to receive RAR. The RAR MAC CE may include a random access preamble identifier (RAPID) 430a that may be mapped to a random access preamble sent by the UE to the secondary access device. The UE may use the RAPID to identify the RAR when the RAPID matches the random access preamble. In some implementations, the UE may distinguish RAR MAC CE 400a (that includes a RAPID 430a) from the normal MAC PDU 400b (that includes a regular LCID 440b) by detecting a “T” bit (Type Field). In the illustrated example shown in FIG. 4, the first bit of a subheader of the RAR MAC CE 400a is an “E” bit 410a, and the second bit is a “T” bit 420a. The first bit of a subheader of a MAC PDU 400b is an “R” bit (Reserved) 410b, the second bit is also an “R” bit 420b, and the third bit is an “E” bit 430b. In some instances, the “R” bit in the DL-SCH MAC subheader is used to indicate that the MAC PDU is a DL-SCH MAC PDU. The “R” bit is pre-determined to be included in the second bit position of the MAC PDU subheader 400b, and the “T” bit is predetermined to be included in the second bit position in the RAR MAC CE sub-header 400a. The value of the “T” bit may be set to a value that is different from the “R” bit. For example, when the “R” bit value is set to “0”, the “T” bit value may be set to “1”, to indicate the presence of a RAPID 430a. Therefore, the UE may be able to distinguish RAR MAC CE 400a and normal MAC PDU 400b with the second bit in the first sub-header. In some implementations, the “R” bit may be renamed as another parameter, e.g. “1” bit, to indicate a DL-SCH MAC PDU.

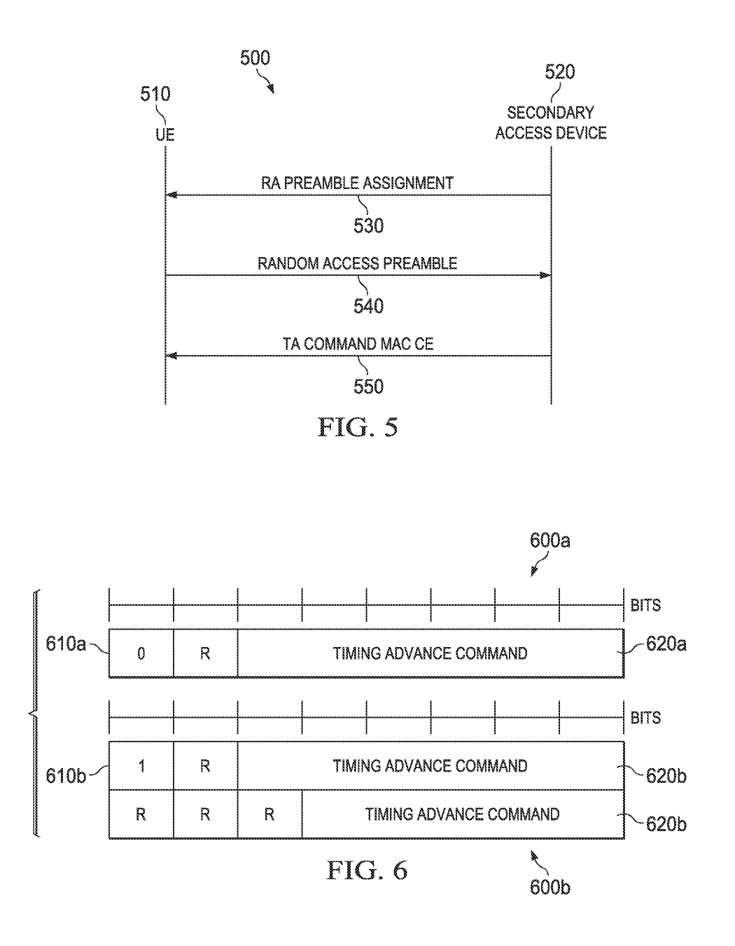

FIG. 5 is a diagram showing an example physical random access channel (PRACH) procedure 500. In the illustrated example, the secondary access device 520 may transmit a TA command as the RAR to the UE during the random access procedure. The TA command may be a TA command MAC CE configured by C-RNTI. In some instances, the TA command MAC CE may be included in the normal DL-SCH MAC PDU. The secondary access device 520 may transmit the TA command in the USS of the SCell. At operation 530, the UE 510 receives a random access preamble assignment from the secondary access device 520. At operation 540, the UE 510 transmits a random access preamble based on the received random access preamble assignment. At operation 550, the UE receives TA command MAC CE from the secondary access device 520. If the UE 510 receives the correct TA command MAC CE, the UE 510 may assume that the secondary access device 520 has correctly detected the random access preamble. If the UE does not receive the TA command MAC CE during the RAR window, the UE may retransmit the random access preamble based on the received random access preamble assignment. If the UE receives PDSCH data but fails to decode the PDSCH data, the UE may transmit a NACK message in physical uplink control channel (PUCCH). Since the PCell uplink is activated and synchronized when carrier aggregation is configured, the UE may send the NACK message in PUCCH in the PCell.

FIG. 6 is a diagram showing a TA MAC CE 600a and a TA command MAC CE 600b. Both the TA MAC CE 600a and the TA command MAC CE 600b may be used by the secondary access device to send TA command as RAR to the UE. In some implementations, the number of bits of TA command in TA MAC CE 600a is 6 bits, and the number of bits of TA command MAC CE 600b in RAR is 11 bits. The TA bits in TA MAC CE 600a may be used to adjust the TA from a deviation of a previously synchronized UE timing. In contrast, the TA command MAC CE 600b may be used in the initial timing adjustment. Therefore, the number of bits for the TA MAC CE 600a may be smaller than the number of bits for the TA command MAC CE 600b. In the illustrated example shown in FIG. 6, if a “T” bit in the first bit position 610a is set to “0”, then a 6 bit short TA command 620a is added. Otherwise, if “T” bit 610b is set to “1”, 11 bit long TA command 620b is added. In some implementations, the UE may assume that the length of TA command MAC CE is the 11 bits TA command MAC CE 620b. In some implementations, a new LCID may be defined in the MAC header to indicate that an 11 bit TA command MAC CE is included.

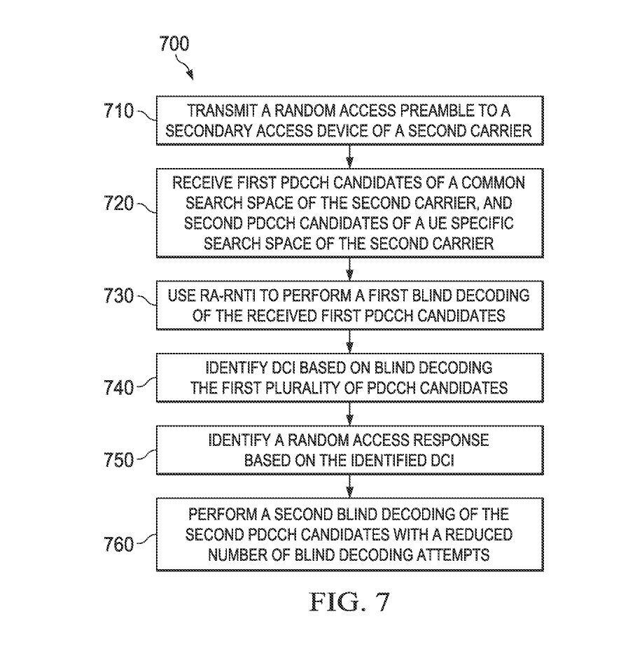

FIG. 7 is a flowchart illustrating an example process 700 of performing random access to a secondary access device. In the illustrated example, a UE is served by both a primary access device of a PCell and a secondary access device of the SCell. DCI for the UE to identify an RAR is encoded in the CSS of a SCell. Network deployment scenario that is suitable for performing the example process 700 may be one of the two deployment scenarios as described in the illustration of FIGS. 1a-1b. In order to not increase the total number of blind decodes while decoding the DCI in the CSS, the UE may reduce the blind decodes in the USS of the SCell. At block 710, a UE transmits a random access preamble to a secondary access device of a second carrier (or SCell).

At block 720, the UE receives first PDCCH candidates of a CSS of the second carrier and second PDCCH candidates of a USS of the second carrier. At block 730, the UE performs a first blind decoding of the received first PDCCH candidates of the CSS of the second carrier. RA-RNTI is used in blind decoding of first PDCCH candidates. As mentioned with regard to FIG. 2, in some implementations, the number of blind decoding attempts for decoding PDCCH candidates of the CSS may be 12. At block 740, the UE identifies DCI for RAR based on blind decoding the first PDCCH candidates. As mentioned with regard to FIG. 2, identifying the DCI may be performed in an RAR window which starts at the subframe that contains the end of the preamble transmission plus three subframes and has a length that is equal to ra-ResponseWindowSize subframes. The RA-RNTI may be associated with the PRACH resource in which the random access preamble is transmitted. The UE may stop monitoring for the RAR after identifying an RAPID included in the RAR that matches the transmitted random access preamble. The UE may use the RA-RNTI to identify the DCI for RAR.

At block 750, the UE identifies an RAR based on the identified DCI. The RAR may be included in the PDSCH. The identified DCI may include information associated with the scheduling information of the RAR in the PDSCH. At block 760, the UE performs a second blind decoding of second PDCCH candidates of the USS of the second carrier. The number of blind decoding attempts for the first and second blind decodings may be maintained to be less than or equal to the configured total number (e.g., 32) of blind decoding attempts for decoding the USS in normal operations. The UE may reduce the blind decoding attempts during the RAR window based on any one of the implementations described in the illustration of FIG. 2.

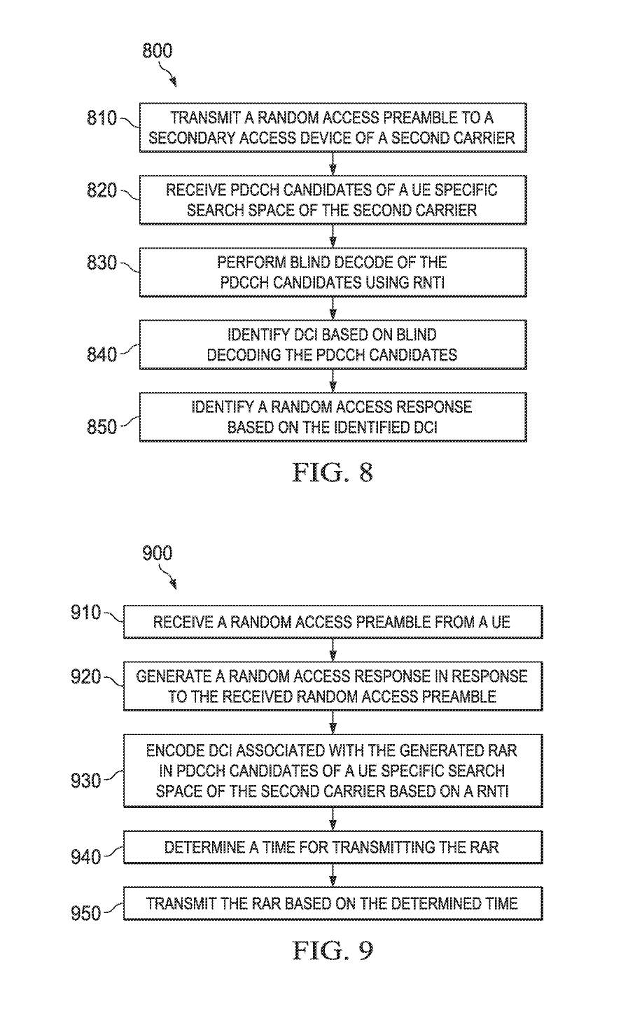

FIG. 8 is a flowchart illustrating another example process 800 of performing random access to a secondary access device. In the illustrated example, a UE is served by both a primary access device of a PCell and a secondary access device of the SCell. DCI for the UE to identify an RAR is encoded in the USS of a SCell. Network deployment scenario of the network that is suitable for performing the example process 800 may be one of the two deployment scenarios as described in the illustration of FIGS. 1a-1b. At block 810, the UE transmits a random access preamble to the secondary access device of the second carrier (or SCell). At block 820, the UE receives PDCCH candidates of a USS of the second carrier. At block 830, the UE uses RNTI to perform blind decoding of the PDCCH candidates in the USS. The RNTI may be an RA-RNTI or a C-RNTI depending on the particular implementation. At block 840, the UE identifies DCI based on blind decoding the received PDCCH candidates. Blind decoding and/or identifying DCI may be based on any one of the implementations described with regard to FIGS. 3-6. At block 850, the UE identifies an RAR based on the identified DCI.

FIG. 9 is a flowchart illustrating an example process 900 of transmitting a random access response. The example process may be performed at a secondary access device, such as the secondary access device described in the illustration of FIGS. 1a-1b. In the illustrated example, a UE is served by both a primary access device of a PCell and a secondary access device of the SCell. DCI for the UE to identify an RAR is encoded in the USS of a SCell. Network deployment scenario of the network that is suitable for performing the example process 900 may be one of the two deployment scenarios as described in the illustration of FIGS. 1a-1b. At block 910, the secondary access device receives a random access preamble from a UE that performs random access to the secondary access device. At block 920, the secondary access device generates an RAR in response to the received random access preamble. The RAR may include configuration information including TA and uplink resource grant for radio access through the secondary access device. At block 930, the secondary access device encodes DCI associated with the generated RAR in PDCCH candidates of a USS of the second carrier based on an RNTI. Encoding DCI may be based on any one of the implementations described with regard to FIGS. 3-6. At block 940, the secondary access device determines a time for transmitting the RAR based on a specific time that the random access preamble is received. At block 950, the secondary access device transmits the RAR based on the determined time in the PDSCH of the second carrier. As such, the RAR is received by the UE in the RAR window.

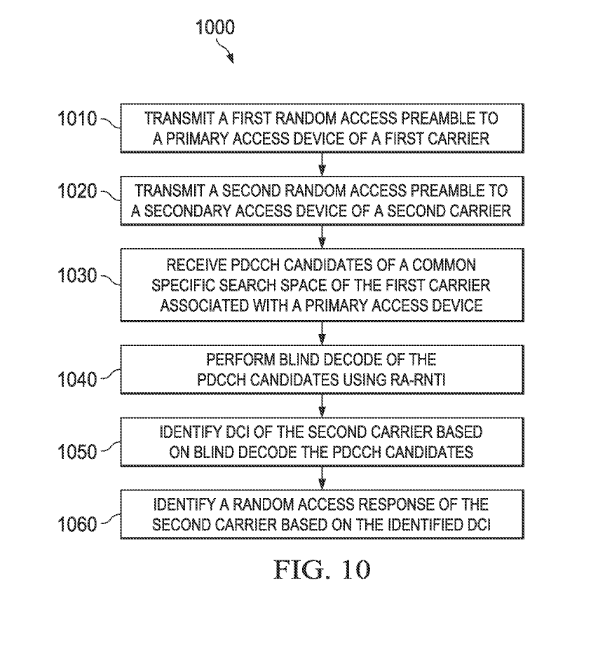

FIG. 10 is a flowchart illustrating yet another example process 1000 of performing random access to a secondary access device. In the illustrated example, a UE is served by both a primary access device of a PCell and a secondary access device of the SCell. DCI for the UE to identify an RAR is encoded in the CSS of a PCell. Network deployment scenario of the network that is suitable for performing the example process 1000 may be one of the two deployment scenarios as described in the illustration of FIGS. 1a-1b. At block 1010, a UE transmits a first random access preamble to a primary access device of a first carrier (or PCell). At block 1020, the UE transmits a second random access preamble to a secondary access device of a second carrier (or SCell). At block 1030, the UE receives PDCCH candidates of a CSS of the primary carrier. At block 1040, the UE uses RA-RNTI to perform blind decoding of the PDCCH candidates. At block 1050, the UE uses an RA-RNTI to identify DCI of the second carrier based on blind decoding the received PDCCH candidates using an RA-RNTI. In some implementations, the RA-RNTI may be configured based on higher layer signaling. At block 1060, the UE identifies an RAR of the second carrier based on the identified DCI.

The RA-RNTI is generated based on indexes of PRACH time and frequency resources that are used to transmit the random access preamble. When the same PRACH frequency and time resources are allocated to both PCell and SCell, the DCI of the PCell and the DCI of the SCell may associate with the same RA-RNTI. In other words, PDCCH candidates associated with the same RA-RNTI may be received at the UE, if the UE transmit random access preamble(s) to the PCell and SCell using the same PRACH resources.

In some implementations, the primary access device (e.g., eNB) may allocate different PRACH time and frequency resources to a UE for PCell and SCell. As such, the UE may transmit the first random access preamble at block 1010 and the second random access preamble at block 1020 using different time and frequency resources. Accordingly, the corresponding RA-RNTIs associated with the PCell and the SCell may be different. The UE may then distinguish RARs from PCell and SCell based on the different RA-RNTIs.

In some implementations, RAPID may be configured to be different for the PCell and the SCell. For example, some of the random access preamble sequences (e.g., non-contention PRACH process) may be reserved exclusively for the SCell. In some instances, the UE may also transmit different random access preamble sequences on the PCell and the SCell RACH to avoid collision of RARs from the PCell and the SCell.

In some implementations, a new RA-RNTI may be reserved for the RAR of the SCell, instead of using the RA-RNTI calculated based on the PRACH resources used to transmit the random access preamble. An access device may signal the new RA-RNTI before a UE transmits the random access preamble to the secondary access device. For example, an RA-RNTI value may be included as a dedicated random access parameter for the SCell in order to distinguish the RARs transmitted in the PCell and the SCell.

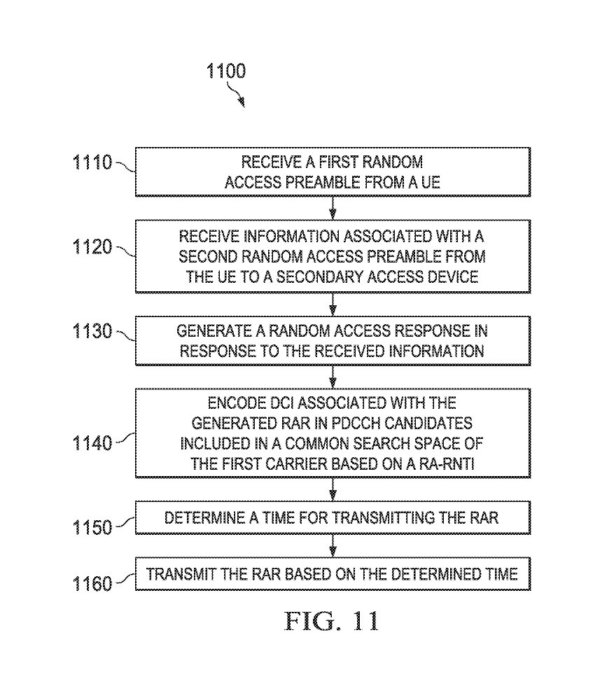

FIG. 11 is a flowchart illustrating another example process 1100 of a transmitting random access response. The example process may be performed at a primary access device, such as the primary access device described in the illustration of FIGS. 1a-1b. In the illustrated example, a UE is served by both a primary access device of a PCell and a secondary access device of the SCell. DCI for the UE to identify an RAR is encoded in the CSS of a PCell. Network deployment scenario of the network that is suitable for performing the example process 1100 may be one of the two deployment scenarios as described in the illustration of FIGS. 1a-1b. At block 1110, the primary access device receives a first random access preamble from the UE. The first random access preamble may be sent by the UE to perform random access to the primary access device. At block 1120, the primary access device receives information associated with a second random access preamble from the UE that performs random access to the secondary access device. In some implementations, the primary access device may receive the information associated with the second random access preamble by eavesdropping on communications between the UE and the secondary access device. In some implementations, information associated with the random access preamble may be received from the secondary access device. At block 1130, the primary access device generates an RAR in response to the received information. At block 1140, the primary access device encodes DCI associated with the generated RAR in PDCCH candidates of a USS of the second carrier based on an RNTI. Encoding DCI may be based on any one of the implementations described with regard to FIG. 10. At block 1150, the primary access device determines a time for transmitting the RAR based on a specific time that the random access preamble is received. At block 1160, the primary access device transmits the RAR based on the determined time in the PDSCH of the second carrier. As such, the RAR is received by the UE in the RAR window.

1. A method performed by a user equipment ‘UE’, the method comprising:
transmitting from the ‘UE’ a random access preamble to a secondary access device of a second carrier, the UE being served by a primary access device and the secondary access device, and the UE configured to attempt a total number of blind decoding attempts for decoding physical downlink control channel ‘PDCCH’ candidates of a UE-specific search space of the second carrier; and
performing a first blind decoding of first PDCCH candidates of the common search space of the second carrier;
performing a second blind decoding of second PDCCH candidates of the UE specific search space of the second carrier,
wherein a number of blind decoding attempts for the first and second blind decodings is less than or equal to the configured total number of blind decoding attempts.

2. The method of claim 1, wherein the primary access device and the secondary access device are not co-located.

3. The method of claim 1, further comprising:
identifying data control information ‘DCI’ based on blind decoding the first PDCCH candidates using a random access radio network temporary identifier ‘RA-RNTI’.

4. The method of claim 3, further comprising:
identifying, in a physical downlink shared channel ‘PDSCH’, a random access response ‘RAR’ associated with the identified DCI.

5. The method of claim 4, further comprising:
determining a time period based on a specific time that the random access preamble is transmitted, and wherein identifying the DCI is performed in the determined time period.

6. The method of 5, wherein blind decoding the first PDCCH candidates is performed by blind decoding at least a subset of the second PDCCH candidates that are not configured by a cell radio network temporary identifier ‘C-RNTI’ during the determined time period.

7. The method of claim 1, wherein the assigned total number of decoding attempts for decoding the PDCCH candidates is determined based on decoding, with two DCI format sizes, control channel element ‘CCE’ subsets of aggregation level 1 that includes one CCE, aggregation level 2 that includes two CCEs, aggregation level 4 that includes four CCEs, and aggregation level 8 that includes 8 CCEs.

8. The method of claim 7, wherein blind decoding the second PDCCH candidates includes decoding the CCE subsets of a subset of the aggregation level 1, the aggregation level 2, the aggregation level 4, and the aggregation level 8.

9. A method performed by a user equipment ‘UE’, the method comprising:
transmitting, from the UE, a random access preamble to a secondary access device of a second carrier, the UE being served by both a primary access device and the secondary access device;
performing blind decoding, from the secondary access device, of physical downlink control channel ‘PDCCH’ candidates;
identifying data control information ‘DCI’ based on a radio network temporary identifier ‘RNTI’, in a UE specific search space of the second carrier; and
identifying a random access response ‘RAR’ that is scheduled with the identified DCI.

10. The method of claim 9, wherein the primary access device and the secondary access device are not co-located.

11. The method of claim 9, further comprising:
determining a time period based on a specific time that the random access preamble is transmitted, and wherein identifying the DCI is performed within the determined time period.

12. The method of claim 9, wherein the RNTI is a radio access RNTI ‘RA-RNTI’, and wherein identifying the RAR is based on the identified DCI.

13. The method of claim 9, wherein the RNTI is a cell RNTI ‘C-RNTI’, and wherein identifying the RAR is based on the identified DCI.

14. The method of claim 13, wherein identifying the RAR is further based on a logical channel identifier ‘LCID’ associated with the RAR.

15. The method of claim 13, wherein identifying the RAR is further based on a value of a type field bit associated with a media access control ‘MAC’ protocol data unit ‘PDU’ for a RAR that is different from a value of a reserved bit associated with a MAC PDU of downlink shared channel ‘DL-SCH’ that is not the RAR.

16. The method of claim 13, wherein the RAR is a timing advance ‘TA’ command, identifying the RAR further includes identifying a TA command media access control ‘MAC’ control element ‘CE’, based on the C-RNTI.

17. The method of claim 16, wherein the TA command includes more than 6 bits.

18. A method performed by a secondary access device, the method comprising:
receiving, from a user equipment ‘UE’, a random access preamble, the UE being served by both a primary access device and the secondary access device;
generating a random access response ‘RAR’ in response to the received random access preamble; and
encoding data control information ‘DCI’ associated with the generated RAR in physical downlink control channel ‘PDCCH’ candidates of a UE specific search space of the second carrier based on a radio network temporary identifier ‘RNTI’.

19. The method of claim 18, wherein the primary access device and the secondary access device are not co-located.

20. The method of claim 18, further comprising:
determining a time for transmitting the RAR based on a specific time that the random access preamble is received; and
transmitting, to the UE, the RAR at the determined time in a physical downlink shared channel PDSCH′.

21. The method of claim 18, wherein the RNTI is a radio access RNTI ‘RA-RNTI’.

22. The method of claim 18, wherein the RNTI is a cell RNTI ‘C-RNTI’, and wherein generating the RAR includes generating a logical channel identifier ‘LCID’ associated with the RAR.

23. The method of claim 22, wherein generating the RAR is further includes generating a value of a type field bit associated with a media access control ‘MAC’ protocol data unit ‘PDU’ for the RAR that is different from a value of a reserved bit associated with a MAC PDU of downlink shared channel ‘DL-SCH’ that is not the RAR.

24. The method of claim 22, wherein the RAR is a timing advance ‘TA’ command.

25. The method of claim 24, wherein the TA command includes more than 6 bits.

26. A method performed by a user equipment ‘UE’, the method comprising:
transmitting, from the UE, a second random access preamble to a secondary access device of a second carrier, the UE being served by both a primary access device and the secondary access device;
performing blind decoding, from the primary access device, of physical downlink control channel (PDCCH) candidates of a common search space of the first carrier;
identifying DCI based on a radio access radio network temporary identifier ‘RA-RNTI’ associated with the second carrier based on the blind decoded PDCCH candidates; and
identifying a second random access response ‘RAR’ based on the identified DCI.

27. The method of claim 26, wherein the primary access device and the secondary access device are not co-located.

28. The method of claim 27, further comprising:
determining a time period based on a specific time that the random access preamble is transmitted, and wherein identifying the DCI is performed within the determined time period.

29. The method of claim 26, further comprising:
receiving information associated with a physical random access channel ‘PRACH’ configuration;
identifying a first PRACH resource for transmitting a first random access preamble to the primary access device, and a second PRACH resource for transmitting the second random access preamble to the secondary access device, based on the received information;
receiving, from the primary access device, a first RAR associated with the identified first PRACH resource; and
wherein the identified second RAR is associated with the identified second PRACH resource.

30. The method of claim 26, further comprising:
identifying second DCI based on a second RA-RNTI associated with the first carrier in the common search space, wherein the second RA-RNTI associated with the first carrier is different from the RA-RNTI associated with the second carrier.

31. The method of claim 29, wherein the RA-RNTI is configured based on higher layer signaling.

32. A method performed by a primary access device, the method comprising:
receiving information associated with a second random access preamble transmitted by a UE to a secondary access device of a second carrier, the UE being served by both the primary access device of a first carrier and the secondary access device;
generating a random access response ‘RAR’ in response to the received information; and
encoding data control information ‘DCI’ associated with the generated RAR in physical downlink control channel ‘PDCCH’ candidates of a common specific search space of the first carrier based on a random access radio network temporary identifier (RA-RNTI).

33. The method of claim 32, wherein the primary access device and the secondary access device are not co-located.

34. The method of claim 32, further comprising:
determining a time for transmitting the RAR based on a specific time that the random access preamble is received; and
transmitting, to the UE, the RAR at the determined time in a physical downlink shared channel ‘PDSCH’.

35. The method of claim 32, further comprising:
configuring a first physical random access channel ‘PRACH’ resource for the UE to transmit a first random access preamble to the primary access device, and a second PRACH resource for the UE to transmit a second random access device; and
transmitting, to the UE, information associated with the configured first PRACH resource and the configured second PRACH resource.

36. The method of claim 32, wherein generating the RAR includes generating a first radio access preamble identifier ‘RAPID’ associated with the RAR that is different from a second RAPID associated with a second RAR in response to a first random access preamble transmitted by the UE to the primary access device.

37. The method of claim 32, wherein the RA-RNTI is configured based on higher layer signaling.

38. (canceled)

39. (canceled)

40. (canceled)
